(19) United States
(12) Patent Application Publication
(10) Pub. No.: US 2026/0361966 A1
(43) Pub. Date: Nov. 12, 2026

(54) MEDIA PLAYBACK METHOD

(71) Applicant: TENCENT TECHNOLOGY (SHENZHEN) COMPANY LIMITED, Shenzhen (CN)

(72) Inventors: Chushi WEI, Shenzhen (CN); Xing LIN, Shenzhen (CN); Hang KANG, Shenzhen (CN); Qinhong ZHENG, Shenzhen (CN); Ying QI, Shenzhen (CN)

(73) Assignee: TENCENT TECHNOLOGY (SHENZHEN) COMPANY LIMITED, Shenzhen (CN)

(21) Appl. No.: 19/722,516

(22) Filed: Jun. 26, 2026

Related U.S. Application Data
(63) Continuation of application No. PCT/CN2025/083415, filed on Mar. 19, 2025.

(30) Foreign Application Priority Data
Apr. 29, 2024 (CN) 202410552009.7

(51) Int. Cl. H04N 21/472; G06V 10/776; H04N 21/431

(52) U.S. Cl. CPC H04N 21/47217; G06V 10/776; H04N 21/4316

(57) ABSTRACT

In a media playback method, a first media object is played in a media interface. Based on a media stream refresh function being triggered by the first user operation, the playback of the first media object is stopped, a second media object is played in the media interface, and a historical replay control element is displayed in the media interface. In the method, based on a second user operation being performed on the historical replay control element, validity verification is performed on the first media object to obtain a validity verification result of the first media object. When the validity verification result of the first media object indicates that the first media object is valid, the first media object is played in the media interface. Apparatus and non-transitory computer-readable storage medium counterparts are also contemplated.

### RELATED APPLICATIONS

The present application is a continuation of International Application No. PCT/CN2025/083415, filed on Mar. 19, 2025, which claims priority to Chinese Patent Application No. 202410552009.7, filed on Apr. 29, 2024, and entitled “MEDIA PLAYBACK METHOD AND APPARATUS, DEVICE, AND READABLE STORAGE MEDIUM.” The entire disclosures of the prior applications are hereby incorporated by reference.

### FIELD OF THE TECHNOLOGY

This disclosure relates to the technical field of computers, including a media playback method and apparatus, a device, and a readable storage medium.

### BACKGROUND OF THE DISCLOSURE

With the rapid development of computer technologies, intelligent applications (such as short video applications and game applications) are increasingly popularized, and various media platforms are further rapidly developed. On some media platforms, different media objects (such as text and videos) are pushed to different objects (e.g., users) in a mode of information streams. For example, the platform may push the media object to the object in a form of media streams for the object to browse and view. One media stream may include a plurality of media objects. In this way, the object may continuously browse and view the media objects in different media streams by continuously performing media pulling operations.

In some applications, when the object views the media object on the media platforms, media playback functions provided by the media platforms are similar. Different media platforms may still offer a monotonous interaction mode for different objects, and the presented interactions remain monotonous.

### SUMMARY

Embodiments of this disclosure include a media playback method and apparatus, a device, and a readable storage medium, to enrich interaction modes and interaction presentation content of a media interface.

In an aspect, an embodiment of this disclosure includes a media playback method. In the method, a first media object is played in a media interface. The first media object is one of one or more media objects included in a first media stream. A first user operation that triggers a media stream refresh function is received during playback of the first media object. Based on the media stream refresh function being triggered by the first user operation, media information of the first media object is recorded, the playback of the first media object is stopped, a second media object is played in the media interface, and a historical replay control element is displayed in the media interface during playback of the second media object. The second media object is one of one or more media objects included in a refreshed second media stream. In the method, a second user operation on the historical replay control element is received. Based on the second user operation being performed on the historical replay control element, validity verification is performed on the first media object to obtain a validity verification result of the first media object. When the validity verification result of the first media object indicates that the first media object is valid, the first media object is played in the media interface. When the validity verification result of the first media object indicates that the first media object is invalid, an invalidity notification indicating that the first media object is not valid for playback is displayed, or another media object included in the first media stream is played in the media interface.

In an aspect, an embodiment of this disclosure includes a media playback apparatus. The media playback apparatus includes processing circuitry configured to play a first media object in a media interface. The first media object is one of one or more media objects included in a first media stream. The processing circuitry is configured to receive a first user operation that triggers a media stream refresh function during playback of the first media object. The processing circuitry is configured to, based on the media stream refresh function being triggered by the first user operation, record media information of the first media object, stop the playback of the first media object, play a second media object in the media interface, and display a historical replay control element in the media interface during playback of the second media object. The second media object is one of one or more media objects included in a refreshed second media stream. The processing circuitry is configured to receive a second user operation on the historical replay control element. The processing circuitry is configured to, based on the second user operation being performed on the historical replay control element, perform validity verification on the first media object to obtain a validity verification result of the first media object. The processing circuitry is configured to, when the validity verification result of the first media object indicates that the first media object is valid, play the first media object in the media interface. The processing circuitry is configured to, when the validity verification result of the first media object indicates that the first media object is invalid, display an invalidity notification indicating that the first media object is not valid for playback, or play another media object included in the first media stream in the media interface.

In an aspect, an embodiment of this disclosure includes a non-transitory computer-readable storage medium. The non-transitory computer-readable storage medium stores instructions, which when executed by a processor, cause the processor to perform a media playback method. In the method, a first media object is played in a media interface. The first media object is one of one or more media objects included in a first media stream. A first user operation that triggers a media stream refresh function is received during playback of the first media object ess. Based on the media stream refresh function being triggered by the first user operation, media information of the first media object is recorded, the playback of the first media object is stopped, a second media object is played in the media interface, and a historical replay control element is displayed in the media interface during playback of the second media object. The second media object is one of one or more media objects included in a refreshed second media stream. In the method, a second user operation on the historical replay control element is received. Based on the second user operation being performed on the historical replay control element, validity verification is performed on the first media object to obtain a validity verification result of the first media object. When the validity verification result of the first media object indicates that the first media object is valid, the first media object is played in the media interface. When the validity verification result of the first media object indicates that the first media object is invalid, an invalidity notification indicating that the first media object is not valid for playback is displayed, or another media object included in the first media stream is played in the media interface.

In an aspect, an embodiment of this disclosure includes a media playback method, including: playing a first media object in a media interface, the first media object being one media object in a first media stream, and the first media stream including one or more media objects; switching to playing a second media object in the media interface in response to a media stream refresh operation (e.g., a media stream refresh function being performed), the second media object being one media object in a refreshed second media stream, and the second media stream including one or more media objects; and switching back, in a playback process of the second media object and in response to a historical replay trigger operation, to playing the first media object in the media interface.

In an aspect, an embodiment of this disclosure includes a media playback apparatus, including: a data playback module, configured to play a first media object in a media interface, the first media object being one media object in a first media stream, and the first media stream including one or more media objects; a first response module, configured to switch to playing a second media object in the media interface in response to a media stream refresh operation (e.g., a media stream refresh function being performed), the second media object being one media object in a refreshed second media stream, and the second media stream including one or more media objects; and a second response module, configured to switch back, in a playback process of the second media object and in response to a historical replay trigger operation, to play the first media object in the media interface.

In an aspect, an embodiment of this disclosure includes a computer device, including: processing circuitry (e.g., a processor) and a memory (e.g., including a non-transitory computer-readable storage medium), the memory having a computer program stored therein, and the computer program, when executed by the processor, causing the processor to perform the method in one or more embodiments of this disclosure.

In an aspect, an embodiment of this disclosure includes a non-transitory computer-readable storage medium, having a computer program stored therein, the computer program including program instructions, and the program instructions, when executed by processing circuitry (e.g., a processor), performing the method in one or more embodiments of this disclosure.

In an aspect of this disclosure, a computer program product is provided, including a computer program, where the computer program is stored in a non-transitory computer-readable storage medium. Processing circuitry (e.g., a processor) of a computer device reads the computer program from the computer-readable storage medium and executes the computer program to cause the computer device to perform the method provided in an aspect of this disclosure.

In an embodiment of this disclosure, a media playback solution is provided, which can enrich the media playback functions provided by the media playback platform, to enrich the interaction modes and interaction presentation content with the object. For example, when the first media object in the first media stream is played in the media interface, if the object viewing the first media object triggers performing the media stream refresh operation(e.g., a media stream refresh function), it may be considered that the object expects to refresh one new media stream, and then the second media object (i.e., one media object in the refreshed second media stream) may be switched for playback in the media interface in response to the media refresh operation. Meanwhile, in this disclosure, the media playback platform provides a replay function for the historically played first media object. In some examples, in the playback process of the second media object, the object may trigger performing the historical replay trigger operation to view, in the media interface, the first media object that is viewed before the media stream refresh operation is performed. Thus, in this disclosure, by adding the replay function for the historically played media objects (such as the media objects of the media stream before the media stream refresh operation is performed), the objects can interact with each other by using the historical replay trigger operation on the media playback platform. The media object played by the object is further newly added to the interaction content presented in the media interface. Accordingly, in this disclosure, the interaction modes and interaction presentation content of the media interface can be enriched.

### BRIEF DESCRIPTION OF THE DRAWINGS

FIG. 1 is a diagram of a network architecture of a media playback system according to an embodiment of this disclosure.

FIG. 2 is a schematic flowchart of a media playback method according to an embodiment of this disclosure.

FIG. 3A is a schematic diagram of a scene of switching to playing a second media object according to an embodiment of this disclosure.

FIG. 3B is a schematic diagram of another scene of switching to playing a second media object according to an embodiment of this disclosure.

FIG. 4 is a schematic diagram of a scene of switching back to playing a first media object according to an embodiment of this disclosure.

FIG. 5 is a schematic diagram of another scene of switching back to playing a first media object according to an embodiment of this disclosure.

FIG. 6 is a schematic diagram of a scene of pulling and playing a media object according to an embodiment of this disclosure.

FIG. 7 is a schematic diagram of a scene of replaying a media object in a playback process of a first media object according to an embodiment of this disclosure.

FIG. 8 is a schematic flowchart of playing a first media object in a media interface according to an embodiment of this disclosure.

FIG. 9 is a diagram of a system interaction logic architecture according to an embodiment of this disclosure.

FIG. 10 is a schematic structural diagram of a media playback apparatus according to an embodiment of this disclosure.

FIG. 11 is a schematic structural diagram of a computer device according to an embodiment of this disclosure.

### DETAILED DESCRIPTION

Descriptions of terms in this disclosure are provided as examples only and are not intended to limit the scope of the disclosure.

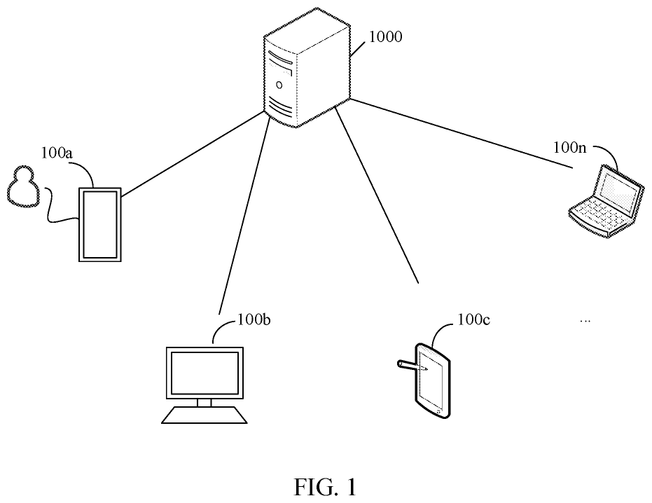

FIG. 1 is a diagram of a network architecture of a media playback system according to an embodiment of this disclosure. As shown in FIG. 1, the network architecture may include a service server 1000 and a terminal device cluster. The terminal device cluster may include one or more terminal devices. A quantity of the terminal device(s) is not limited herein. As shown in FIG. 1, a plurality of terminal devices may include a terminal device 100a, a terminal device 100b, a terminal device 100c, . . . , and a terminal device 100n. As shown in FIG. 1, the terminal device 100a, the terminal device 100b, the terminal device 100c, . . . , and the terminal device 100n may establish a network connection with the service server 1000, respectively, so that each terminal device may perform data interaction with the service server 1000 by using the network connection. In addition, any terminal device in the terminal device cluster 100 may be an intelligent device running an operating system. The operating system of the terminal device is not limited in this disclosure.

The terminal device in a data processing system as shown in FIG. 1 may be a smartphone, a tablet computer, a laptop computer, a desktop computer, a mobile Internet device (MID), a point of sales (POS) machine, a smart speaker, a smart television, a smart watch, a smart vehicle-mounted terminal, a virtual reality (VR) device, an augmented reality (AR) device, or the like, but is not limited thereto. The terminal device is generally equipped with a display apparatus. The display apparatus may be a display, a display screen, a touchscreen, or the like. The touchscreen may be a touch-sensitive screen, a touch panel, or the like.

The service server in the data processing system as shown in FIG. 1 may be an independent physical server, or may be a server cluster or a distributed system including a plurality of physical servers, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence (AI) platform. The terminal device and the service server may be connected directly or indirectly in a wired communication manner or a wireless communication manner, which is not limited in this disclosure.

In an embodiment of this disclosure, one terminal device may be selected from the plurality of terminal devices as a target terminal device. The terminal device may include: an intelligent terminal carrying a multimedia data processing function (such as a video playback function, a music data playback function, and a text playback function), such as a smartphone, a tablet computer, a notebook computer, a desktop computer, a smart television, a smart speaker, a desktop computer, a smartwatch, a smart in-vehicle device, a head-mounted devices, smart home devices, and a smart speech interaction device, but is not limited thereto. For example, in an embodiment of this disclosure, a terminal device 100a shown in FIG. 1 may be used as the target terminal device. The foregoing service applications may be integrated into the target terminal device. In this case, the target terminal device may exchange data with the service server 1000 through the service applications. The service server 1000 in this disclosure may acquire service data based on these applications. For example, the service server 1000 may acquire the service data by using a bound account of a specific object. The bound account may be an account bound by the object in this disclosure. The object may log in to the application, upload data, acquire data, and the like by using the corresponding bound account. The service server may further acquire a login status of the object and the uploaded data, transmit data to the object, and the like by using the bound account.

As shown in FIG. 1, the service application may be installed in each terminal device. When running in each terminal device, the service application may exchange data with the service server 1000 shown in FIG. 1, so that the service server 1000 may receive the service data from each terminal device. The service application may include an application having a function of displaying data information such as text, an image, an audio, and a video. For example, the application may be a browser, a video application, an entertainment application (such as a game application), or a novel application. Examples are not provided herein. The application may be an independent application, or may be an embedded sub-application integrated in a specific application (such as an education application or a multimedia application). This is not limited herein. Using an example in which the application is a video application, the service server 1000 may be a set of multiple servers, such as a background server and a data processing server, that correspond to the video application. Therefore, each terminal device may transmit data to the service server 1000 by using the video application. For example, each terminal device may upload local data such as images or videos to the service server 1000 by using the video application, so that the service server 1000 may deliver the data such as the image or the video to another terminal device or transmit the data to a cloud server. The service application in this disclosure may have a media playback function and may be used as a media playback platform.

In one or more embodiments of this disclosure, an example in which the service application is a video application is used for description. An object (such as a user or an intelligent robot) may run the video application in the terminal device. The video application may push different media objects (such as videos) to the object in a form of a media stream (the media stream may include an ordered media object sequence, and the media object sequence includes one or more media objects, such as a video stream). The objects may view the media objects in the media interface of the terminal device (the media objects are browsed and viewed successively based on an order of the media object sequence). When using the video application, the object may perform an operation for pulling the media object (which may be referred to as a media pulling operation) in the video application, to request updating and displaying a next media object in the media interface. The media pulling operation herein may refer to a sliding operation (for example, the sliding herein may refer to sliding in a specific direction, specifically such as sliding upward, sliding downward, sliding leftward, and sliding rightward) in the media interface, and may further refer to a double-click/double-tap operation on the media interface, an operation for triggering a control, or the like. This is not limited in this disclosure.

In some examples, a media stream refresh function is provided in each application (such as the video application). Different objects may refresh the currently pushed and displayed media stream by performing a media stream refresh operation (e.g., a media stream refresh function) in the application. For example, using an object a as an example, when the object uses the video application, a media stream currently pushed to an object 1 is a media stream 1 (the media stream 1 includes a media object sequence {a media object 1, a media object 2, a media object 3, a media object 4, and a media object 5}), and a media object currently viewed by the object 1 is the media object 3 in the media stream 1. In this case, if the object 1 performs the media pulling operation, the terminal device may respond to this operation and switch to displaying and playing a next media object in the media interface (i.e., the media object 4) of the media object 3. However, if the object 1 performs the media stream refresh operation (e.g., a media stream refresh function), the terminal device may respond to this operation, load a new media stream (such as a media stream 4, where the media stream 4 includes a media object sequence {a media object 41, a media object 42, a media object 43, a media object 44, and a media object 45}), and switch to displaying and playing the first media object (i.e., the media object 41) in the new media stream in the media interface after the new media stream is loaded.

Each application (such as the video application) provides a single function, which means that an interaction mode with the object (such as the user) is equally relatively monotonous, and the interaction content presented to the object is equally relatively monotonous. For example, if the video application provides only the media stream refresh function and the media pulling function, the objects may interact with the video application by triggering performing the media stream refresh operation and the media pulling operation in the video application. For example, when the object triggers performing the media stream refresh operation, the terminal device may respond to this operation and present, in the media interface, the interaction content (i.e., a media object in the new media stream, such as the first media object) corresponding to this operation. For another example, when the object triggers performing the media pulling operation, the terminal device may respond to this operation and present, in the media interface, the interaction content (i.e., a next media object of the currently played media object) corresponding to this operation. Regardless of the media stream refresh function or the media pulling function, the interaction content presented to the object is a “new” media object (such as the next media object in the new media stream or the next media object in the same media stream) that is not viewed and played by the object. The simple interaction mode and interaction presentation content have the following problems: if an object mistakenly triggers performing the media stream refresh operation when viewing a media object, the terminal device may respond to this operation and present the media object of the new media stream in the media interface. The media object just viewed by the object may disappear and may not be easily retrieved. If the media object before the media stream is refreshed meets a media browsing requirement of the object, this may not only affect the application usage experience of the objects, but also affect the reputation of the video application, thereby reducing a download rate, a conversion rate, or the like of the video application.

Based on this, this disclosure provides a media playback solution, which can provide a retrieval function for the historically played media objects in the application (such as the video application), and enrich interaction modes with the object and the interaction presentation content. As a result, in a case that the object mistakenly triggers the media stream refresh operation when using the application (such as the video application), the object can replay the media object and the media stream played before the media stream refresh operation by triggering performing a replay operation for the historically played media object. To be specific, the interaction modes and interaction presentation content of the video application are newly added in the media playback solution provided in this disclosure. The newly added interaction mode of the video application is a replay interaction mode for the historically played media object. The newly added interaction presentation content of the video application is that the object further views the played media object. The media playback solution involved in this solution may include at least three consecutive operations. 1. When the object views a media object (such as a media object in a media stream, for ease of distinction herein, the media object that is being viewed by the object may be referred to as the first media object, and the media stream to which the first media object belongs may be referred to as a first media stream) in the media interface of the video application, a new media stream may be refreshed and played by triggering performing the media stream refresh operation (for ease of distinction herein, the new media stream may be referred to as a second media stream). 2. After receiving the media stream refresh operation triggered by the object, the terminal device may respond to the operation of the object and first load the new media stream (i.e., the second media stream, where the terminal device may download the new media stream from the service server), and may switch to playing a media object in the second media stream in the media interface (the media object switched for playback herein may be referred to as the second media object, and usually, when switching to playing the new media stream, the media object may be played sequentially according to an order of the media object sequence in the media stream, namely, the first media object in the media stream is first played, and the second media object herein is at the first position in the second media stream) after the second media stream is loaded. 3. In a playback process of the second media object, since the video application provides the replay function for the historically played media object (the historically played media object may refer to the media object that is already played in the media stream that is being viewed by the object before the media stream refresh operation is performed, such as the first media object), the object may perform the historical replay trigger operation to request replaying the first media object again, and in this way, the terminal device may respond to the historical replay trigger operation and switch back to playing the first media object in the media interface.

When an object plays and views the first media object in the first media stream, the replay function for the historically played media object (such as the first media object) may be provided for the object after the object performs the media stream refresh operation, and the object may view the first media object again by performing the historical replay trigger operation. In this way, when the object mistakenly triggers the media stream refresh operation, the media object that is being viewed by the object before the media stream refresh operation is triggered may be retrieved, thereby better improving the experience of the object.

The method provided in an embodiment of this disclosure may be performed by a computer device. The computer device includes, but is not limited to, a terminal device or a service server. The service server may be an independent physical server, may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and AI platform.

The terminal device and the service server may be directly or indirectly connected in a wired or wireless communication manner. This is not limited in this disclosure.

In some embodiments, the computer device (such as the service server 1000, the terminal device 100a, or the terminal device 100b) may be one node in the distributed system. The distributed system may be a blockchain system, and the blockchain system may be a distributed system formed by connecting a plurality of nodes in a network communication form. In the distributed system, the computer device in any form, such as the service server, the terminal device, and another electronic device may become one node in the blockchain system by joining a peer-to-peer network. For ease of understanding, a concept of a blockchain is described below. The blockchain is a new application pattern of computer technologies such as distributed data storage, peer-to-peer transmission, consensus mechanisms, and encryption algorithms. The blockchain is primarily configured to organize data in chronological order and encrypt the data into a ledger that is resistant to tampering or forgery, while further enabling data verification, storage, and updating. When the computer device serves as a blockchain node, the tamper-proof and anti-forgery features of the blockchain can help ensure that the data (such as media objects, played media objects, etc.) in this disclosure can be endowed with authenticity and security, thereby making results obtained after performing relevant data processing based on these data more reliable.

In a specific implementation of this disclosure, object-related data such as object information and object data (such as the bound account of the object and data uploaded by the object) are acquired and processed only after obtaining the permission granted by the object. When an embodiment of this disclosure is applied to a specific product or technology, permission or consent of the object needs to be obtained, and collection, usage, and processing of related data need to comply with related laws, regulations, and standards of related regions.

Based on the foregoing solution, an embodiment of this disclosure provides a more detailed media playback method. The media playback method provided in one or more embodiments of this disclosure may be described in further detail below with reference to the drawings.

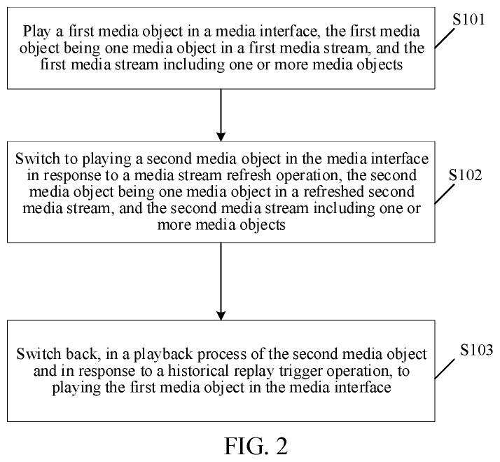

FIG. 2 is a schematic flowchart of a media playback method according to an embodiment of this disclosure. The media playback method may be performed by the computer device in the foregoing system. The computer device may be any terminal device (such as the terminal device 100a) in the terminal device cluster in an embodiment corresponding to FIG. 1 or the service server 1000. The computer device may further include a terminal device and a service server. For ease of understanding, one or more embodiments are described with non-limiting examples in which the method is performed by the terminal device. The media playback method may include at least the following operations S101 to S103:

Operation S101: Play a first media object in a media interface, the first media object being one media object in a first media stream, and the first media stream including one or more media objects. For example, a first media object is played in a media interface, the first media object being one of one or more media objects included in a first media stream.

In this disclosure, the media interface may refer to an application page (such as a home page interface, a recommendation page, or a follow list page of an application) in the service application. The service application may refer to any application that has a media playback function (such as a text playback function, a video playback function, or an audio playback function) and that is installed in the terminal device. For example, the service application may be a browser, a video application, an entertainment application (such as a game application), or a novel application. The service application may be an independent application, or may be an embedded sub-application in an application such as a video application, an entertainment application, or a shopping application. This is not limited herein. After an object (such as a user or an intelligent robot) launches a service application in the terminal device, the terminal device may display the media interface of the service application, and display and play, in the media interface, the media object pushed to the object. The media object may refer to an object presented in any media presentation form. The media presentation form may include, but is not limited to, a video presentation form, an image presentation form, an audio presentation form, and the like. The media object may refer to an object presented in the video presentation form, such as a video; or the media object may refer to an object presented in an image presentation form, such as an image. To be specific, one media object may refer to one video, one image, one audio, or the like. The service application may push the media object to the object in a form of a media stream (such as a video stream). The media stream herein may be understood as one media object sequence that includes one or more media objects. After one media stream is pushed to the object, the object may successively view the media objects in the media object sequence according to an arrangement order of the media object sequence in the media stream. Quantities of the media objects included in each media stream in this disclosure may be the same or may be different. This is not limited in this disclosure.

Based on the foregoing description, the first media object in this disclosure may refer to a media object in a media stream that is being viewed by the object (i.e., the media object that is being displayed and played in the media interface) when the object uses the service application. For ease of distinction, the media object that is currently being viewed and played by the object (i.e., the media object that is being viewed and played by the object at a specific moment) is referred to as the first media object, and the media stream to which the first media object belongs is referred to as the first media stream.

Operation S102: Switch to playing a second media object in the media interface in response to a media stream refresh operation (e.g., a media stream refresh function being performed), the second media object being one media object in a refreshed second media stream, and the second media stream including one or more media objects.

In some examples, a first user operation that triggers a media stream refresh function is received when playback of the first media object is in progress. In some examples, based on the media stream refresh function being triggered by the first user operation, media information of the first media object is recorded, the playback of the first media object is stopped, and a second media object in the media interface is played. In some examples, the second media object is one of one or more media objects included in a refreshed second media stream. In some examples, a historical replay control element is displayed in the media interface during playback of the second media object.

In this disclosure, when the object triggers the media stream refresh operation while playing and viewing the first media object, the terminal device may respond to this operation and first load a new media stream (which may be referred to as the second media stream for ease of distinction) that is different from the first media stream. After the new media stream is loaded, the terminal device may switch to playing one media object in the second media stream in the media interface (since the media stream includes one media object sequence, usually when the media stream is pushed to the object for playback, the media objects in the media stream may be successively played according to an arrangement order of the media object sequence. Based on this, the media object that is switched for playback herein may be referred to as the first media object in the second media stream). The media object in the second media stream switched for playback may be referred to as the second media object in this disclosure.

In a specific implementation, the media stream refresh operation may refer to a trigger operation performed by the object on a control (such as a media stream refresh control) or a specified region in the media interface. The trigger operation herein may include a contact operation such as clicking/tapping, long pressing, or sliding in a direction (such as sliding upward, sliding downward, sliding leftward, or sliding rightward), or may include a non-contact operation such as a voice or a gesture. This is not limited herein. For example, the media stream refresh operation may refer to a touchscreen tapping operation performed by the object on the media stream refresh control in the media interface. For another example, in some scenes, when using the service application on the terminal device, the object may perform a scroll-to-top operation by tapping a top status bar in the media interface (the status bar is a region that displays information such as a network carrier, a signal value, a network status, and a remaining battery level of the device). In some service applications (such as a video pushing application), the scroll-to-top refers to returning to the top (i.e., the first media object) of the entire media stream, and refreshing the media stream for the object. In this scene, the media stream refresh operation may further refer to a scroll-to-top operation performed by the object in the media interface.

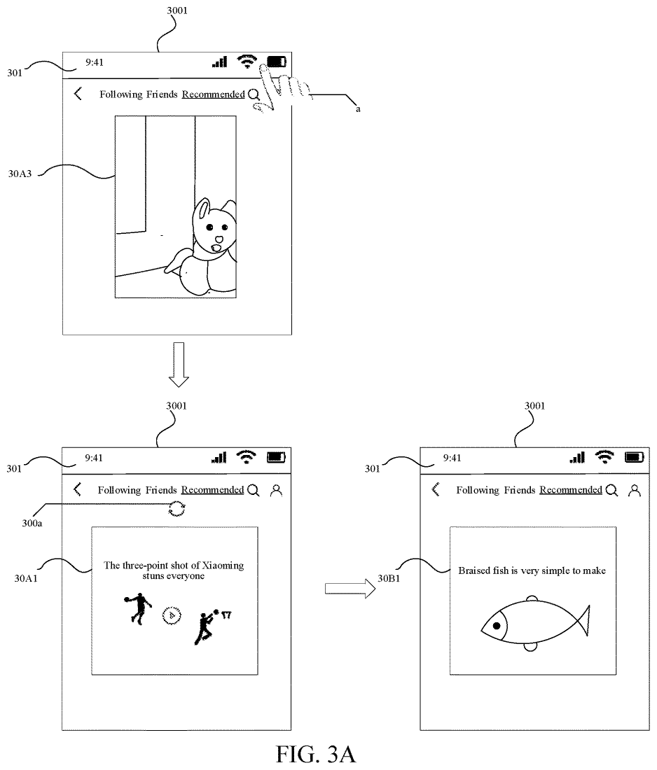

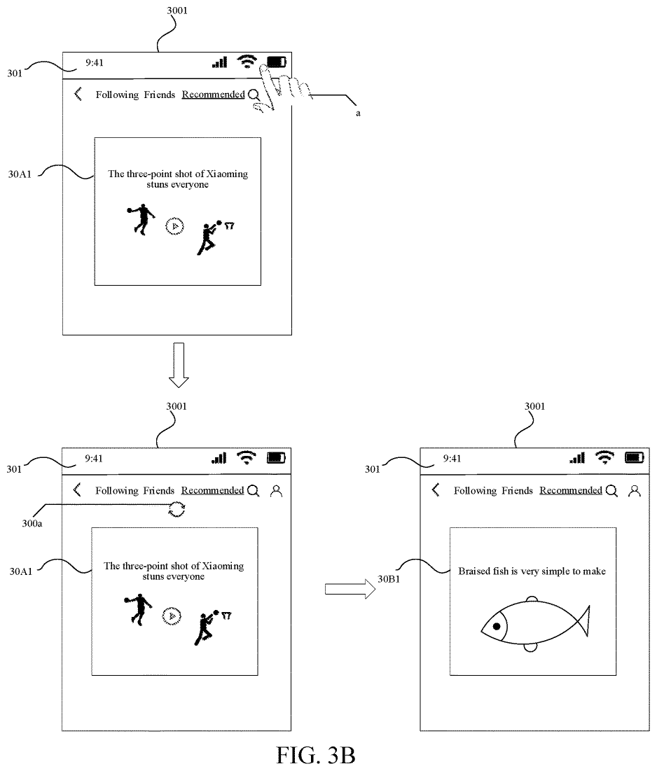

To facilitate understanding a specific process of switching to playing the second media object, a scene of switching to playing the second media object is described below with reference to the drawings. FIG. 3A is a schematic diagram of a scene of switching to playing a second media object according to an embodiment of this disclosure. The scene shown in FIG. 3A is described by using an example in which the service application is a video application, the media object is a video, and the media stream is a video stream.

As shown in FIG. 3A, it is assumed that when using the video application in the terminal device, the object a is playing and viewing a video 30A3 in a media interface 3001, where a video stream to which the video 30A3 belongs is a video stream A, and a video sequence included in the video stream A is {a video A1, a video A2, a video A3, a video A4, a video A5, a video A6, a video A7, a video A8, a video A9, a video A10}. Therefore, it may be seen that the video A3 is the third video in the video stream A. In the video application, the video stream is usually pushed to the object sequentially according to an arrangement order of the video sequence. To be specific, the first media object that is currently played in the media interface is the video 30A3, and before the object a views the video 30aA3, the video 30A1 and the video 30A are already played and viewed, so that the video stream A to which the video 30A3 belongs may be determined as the first media stream. Then, if the object a performs a trigger operation on a status bar region 301 in the media interface 3001, the terminal device may determine that the object a performs a scroll-to-top operation during the playback of the video 30A3. The scroll-to-top operation is the media stream refresh operation. The terminal device may return the media object played in the media interface to the top (i.e., return to the first video, i.e., the video 30A1, of the video stream A), and load one new video stream different from the video stream A (the terminal device may download one new video stream from the service server). Moreover, in a loading process, a playback waiting animation (a playback waiting animation 300a shown in FIG. 3A) is displayed in the media interface 3001 and configured for representing that loading is currently being performed and the object a is requested to wait a moment. For example, as shown in FIG. 3A, after the object a triggers the status bar region 301, the terminal device may respond to the scroll-to-top operation of the object a and return the media object that is played in the media interface 3001 to the top (i.e., the first video) of the current video stream A. In addition, during the playback of the top video (i.e., the video 30A1), the terminal device may further display the playback waiting animation 300a in the media interface 3001, to represent that a new video stream is being loaded currently and request the object to wait.

Assuming herein that the new video stream loaded by the terminal device in an embodiment is the video stream B, the video stream B may be used as the second media stream to be pushed to the object a. Herein, an example in which a video sequence included in the video stream B is {a video 30B1, a video 30B2, a video 30B3, a video 30B4, a video 30B5, a video 30B6, a video 30B7, a video 30B8} is used. After the terminal device loads the video stream B, the terminal device may hide the playback waiting animation 300a in the media interface 3001, and switch to playing the first video (i.e., the video 30B1) in the video stream B in the media interface 3001. The video 30B1 may be used as the second media object.

As shown in the scene of switching to playing the second media object in FIG. 3A, in this disclosure, in a case that the user plays and views the media stream in an arrangement order of the media object sequence in the media stream, if the first media object is not the first media object in the first media stream, then after the object triggers the scroll-to-top operation, the terminal device may first return the media object to the first media object of the currently played media stream and display the playback waiting animation in the playback process of the first media object. Only after the second media stream is loaded, the playback waiting animation may be closed, and the media object played in the interface is switched to the second media object in the second media stream. In this disclosure, for ease of distinction, the media object sequence included in the first media stream may be referred to as a first media object sequence, and the media object sequence included in the second media stream may be referred to as a second media object sequence. Therefore, in this disclosure, in a case that the first media stream includes the first media object sequence, the first media object is at a non-first position in the first media object sequence, and the media stream refresh operation refers to the scroll-to-top operation, a specific implementation process of switching to playing the second media object in the media interface may at least include but is not limited to: first, switching to playing a historically played media object (the historically played media object is at the first position in the first media object sequence, such as the video 30A1 shown in FIG. 3A) in the media interface, and playing the playback waiting animation (such as the playback waiting animation 300a shown in FIG. 3A) in the media interface during the playback of the historically played media object; and hiding the playback waiting animation after the second media stream (such as the video stream B shown in FIG. 3A) is loaded, and switching to playing the second media object (such as the video 30B1 shown in FIG. 3A) in the media interface.

In some examples, the first media object is at a non-first position in the first media object stream. In some examples, the media stream refresh function corresponds to a scroll-to-top operation. In some examples, based on the media stream refresh function being triggered by the first user operation, when loading of the second media stream is in progress and after the playback of the first media object is stopped, a top media object that is at a first position in the first media object stream is displayed in the media interface, and a playback waiting animation is displayed in the media interface during playback of the top media object. In some examples, based on the media stream refresh function being triggered by the first user operation, when the loading of the second media stream is completed, the playback waiting animation is hidden, the display of the top media object is stopped, and the playback of the second media object is started in the media interface.

The above describes a scene of switching to playing the second media object in the media interface when the first media object is at the non-first position in the first media stream. However, when the first media object is at the first position in the first media stream, since the first media object is already the first media object in the currently played first media stream and is already located at a top position of the first media stream, even if the media stream refresh operation refers to the scroll-to-top operation, the terminal device does not need to perform scroll-to-top processing on the media object in the media interface. Based on this, in this case, a specific implementation process of switching to playing the second media object in the media interface may at least include but is not limited to: first, displaying the playback waiting animation in the media interface; and next, hiding the playback waiting animation after the second media stream is loaded, and switching to playing the second media object in the media interface.

To facilitate understanding the scene of switching to playing the second media object in the media interface when the first media object is at the first position in the first media stream, FIG. 3B is a schematic diagram of another scene of switching to playing a second media object according to an embodiment of this disclosure. The scene shown in FIG. 3B is still described by using an example in which the service application is a video application, the media object is a video, and the media stream is a video stream.

As shown in FIG. 3B, it is assumed that when using the video application in the terminal device, the object a is playing and viewing the video 30A1 in the media interface 3001, where the video stream to which the video 30A1 belongs is the video stream A, and a video sequence included in the video stream A is {a video A1, a video A2, a video A3, a video A4, a video A5, a video A6, a video A7, a video A8, a video A9, a video A10}. It may be seen that the video A1 is the first video in the video stream A. In the video application, the video stream is usually pushed to the object sequentially according to the arrangement order of the video sequence. To be specific, the first media object that is currently being played in the media interface is the video 30A1, and the video stream A to which the video 30A1 belongs may be determined as the first media stream. Then, the object a performs a trigger operation on the status bar region 301 in the media interface 3001, and then the terminal device may consider that the object a performs the scroll-to-top operation in the playback process of the video 30A1. The scroll-to-top operation is the media stream refresh operation. The terminal device may return the media object played in the media interface to the top (namely, return to the first video, i.e., the video 30A1, of the video stream A), and load one new video stream different from the video stream A (the terminal device may download one new video stream from the service server). Moreover, in a loading process, the playback waiting animation is displayed in the media interface 3001 and configured for representing that loading is currently being performed and the object a is requested to wait a moment. However, since the current video 30A1 is already the first video of the video stream A, there is no need to scroll to the top, and it is only necessary to display the playback waiting animation in the playback process of the video 30A1. For example, as shown in FIG. 3B, after the object a triggers the status bar region 301, the terminal device may respond to the scroll-to-top operation of the object a and display the playback waiting animation 300a in the media interface 3001 during the continuous playback of the video 30A1 in the media interface 3001, to represent that a new video stream is being loaded currently and request the object to wait.

Assuming herein that the new video stream loaded by the terminal device in an embodiment is the video stream B, the video stream B may be used as the second media stream to be pushed to the object a. Herein, an example in which a video sequence included in the video stream B is {a video 30B1, a video 30B2, a video 30B3, a video 30B4, a video 30B5, a video 30B6, a video 30B7, a video 30B8} is used. After the terminal device loads the video stream B, the terminal device may hide the playback waiting animation 300a in the media interface 3001, and switch to playing the first video (i.e., the video 30B1) in the video stream B in the media interface 3001. The video 30B1 may be used as the second media object.

In some examples, the first media object is at a first position in the first media stream. In some examples, based on the media stream refresh function being triggered by the first user operation, when loading of the second media stream is in progress, a playback waiting animation is displayed in the media interface during playback of the first media object. In some examples, based on the media stream refresh function being triggered by the first user operation, when the loading of the second media stream is completed, the playback waiting animation is hidden, the playback of the first media object is stopped, and the playback of the second media object is started in the media interface.

Operation S103: Switch back, in a playback process of the second media object and in response to a historical replay trigger operation, to playing the first media object in the media interface.

In some examples, a second user operation on the historical replay control element is received. In some examples, based on the second user operation being performed on the historical replay control element, validity verification on the first media object is performed to obtain a validity verification result of the first media object. In some examples, when the validity verification result of the first media object indicates that the first media object is valid, the first media object is played in the media interface. In some examples, when the validity verification result of the first media object indicates that the first media object is invalid, an invalidity notification indicating that the first media object is not valid for playback is displayed, or another media object included in the first media stream is played in the media interface.

In some examples, a historical replay notification is outputted with display of the historical replay control element. In some examples, the historical replay notification includes an audio notification, a dynamic virtual character displayed in the media interface, or a static text notification displayed in a playback region of the playback of the second media object. In some examples, the historical replay notification is displayed in the historical replay control element.

In this disclosure, a replay function is newly added to a platform (such as the service application) for playing the media object. Therefore, to prompt the object, which uses the service application, that the historically played media object may be replayed, after the second media object is switched for playback, in this disclosure, a historical replay notification may be outputted in the playback process of the second media object. The historical replay notification may be configured to notify the object using the service application that the historically played media object (such as the media object played and viewed before the media stream refresh operation is performed: i.e., the first media object) may be retrieved by performing a historical replay trigger operation. An output mode of the historical replay notification may at least include, but is not limited to, any one of the following types: outputting in an audio form (namely, during the playback of the second media object, one historical replay prompt audio is outputted by the terminal device at the same time, and for example, the audio is that you can replay the video that is just viewed by performing the historical replay trigger operation); displaying in a form of a dynamic virtual character in the media interface (for example, a dynamic “Pikachu” virtual character is displayed in the media interface, to prompt the object to perform the historical replay trigger operation to replay the video that is just viewed); and displaying in a form of static text on the second media object in a playback region of the second media object (i.e., in the playback region of the second media object, one piece of text information is displayed to prompt the object to perform the historical replay trigger operation to replay the video that is just viewed. For example, the text information may be that you can replay the video that is just viewed by performing the historical replay trigger operation). In some examples, the output mode of the historical replay notification is illustrated herein with an example for ease of understanding, but this does not mean that the output mode of the historical replay notification is limited thereto. The output mode of the historical replay notification is not limited in this disclosure.

In a feasible embodiment, the terminal device may further display a historical replay control element in the media interface. The historical replay control element may be temporarily displayed in the playback process of the second media object after the second media object is switched for playback. The historical replay control element may further be synchronously displayed along with the display of the media interface (namely, the historical replay control element may be permanently displayed in the media interface). A display mode of the historical replay control element is not limited in this disclosure. The historical replay trigger operation in this disclosure may be a trigger operation performed by the object on the historical replay control element. In a feasible embodiment, in a case that the media interface includes the historical replay control element, the foregoing historical replay notification may be displayed in the historical replay control element.

In some examples, the historical replay notification includes operation guidance of the second user operation. In some examples, the second user operation indicated by the operation guidance includes an operation for inputting a specified gesture in the media interface, or an operation for inputting utterance data.

In some examples, in addition to referring to the trigger operation on this historical replay control element, the historical replay trigger operation may further refer to another specified operation, for example, the historical replay notification may include operation guidance of the historical replay trigger operation, and the historical replay trigger operation is then an operation performed on the media interface based on a specified operation indicated by the operation guidance. The specified operation indicated by the operation guidance may at least include, but is not limited to, any one or more of the following types: inputting a specified gesture operation in the media interface (the specified gesture operation herein may refer to a touchscreen sliding operation, a non-contact gesture operation, or the like. For example, the specified gesture operation may refer to sliding a distance in a direction in the media interface); and inputting utterance data configured for triggering the historical replay operation (namely, the user may input a piece of utterance data by using the terminal device to replay the first media object). A specific meaning of the historical replay trigger operation is illustrated herein with an example for ease of understanding, but this does not mean that a mode for performing the historical replay trigger operation is limited thereto. The mode for performing the historical replay trigger operation is not limited in this disclosure.

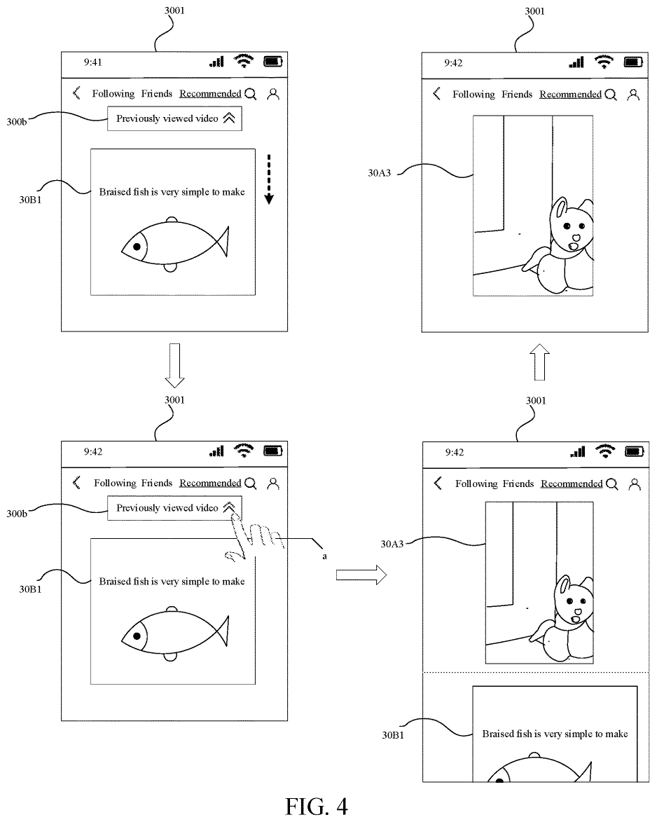

To facilitate understanding a specific scene of switching back to playing the first media object in a case that the historical replay notification is outputted, the following describes the scene with reference to the drawings. FIG. 4 is a schematic diagram of a scene of switching back to playing a first media object according to an embodiment of this disclosure. With reference to FIG. 3A, after loading the video stream B, the terminal device may switch to playing the video 30B1 in the video stream B in the media interface 3001. The video 30B1 is the second media object. In the playback process of the video 30B1, the historical replay control element 300b may be outputted and displayed in the media interface 3001, and a historical replay notification (such as static text “a video that is just being viewed” shown in FIG. 4) may be displayed in the historical replay control element 300b. By using the historical replay notification in the historical replay control element 300b, the object a may be prompted to perform the historical replay trigger operation to switch back to playing the video 30A3 that is just being viewed. The historical replay trigger operation herein may refer to a trigger operation for the historical replay control element 300b, or may refer to an operation of sliding, in the media interface, in an arrow direction shown in FIG. 4. As shown in FIG. 4, an example in which the object a triggers the historical replay control element 300b is used. After the object a triggers the historical replay control element 300b, the terminal device may respond to this operation and switch the media object played in the media interface 3001 from the video 30B1 to the video 30A3. For example, as shown in FIG. 4, a final video played in the media interface 3001 is the video 30A3.

In this disclosure, a mode for performing the historical replay trigger operation may be displayed in the media interface (for example, as shown in FIG. 4, the historical replay control element 300b or the historical replay notification is displayed in the media interface) for the object to know; and the mode for performing the historical replay trigger operation may further be presented in application description information such as an application usage description, an application usage announcement, or an application version description of the service application for the object to view and know. A publishing form of the mode for performing the historical replay trigger operation is not limited in this disclosure.

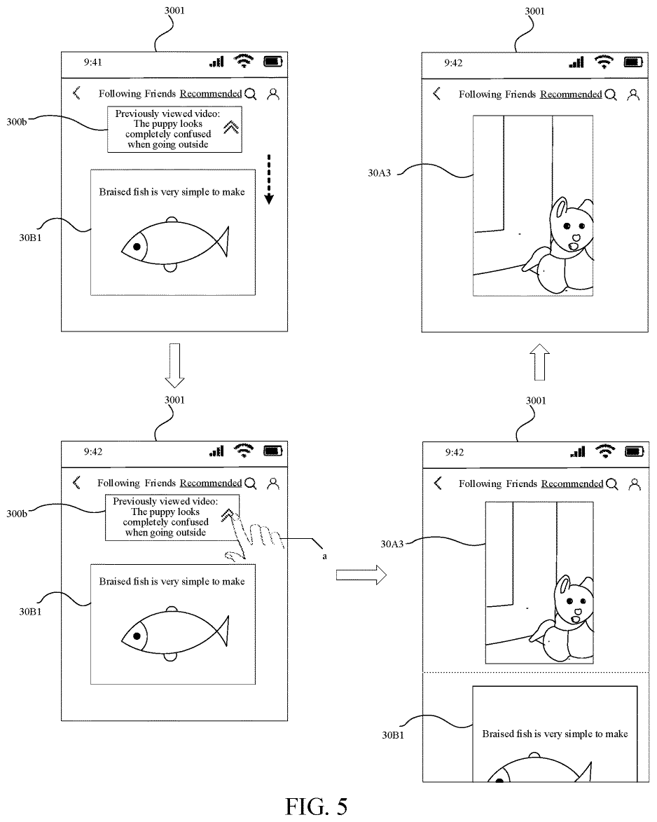

In a feasible embodiment, the historical replay notification outputted in this disclosure may further include relevant information of the media object that can be replayed to prompt the objects which media object can be replayed. The relevant information of the media object included herein may include, but is not limited to, title information of the media object, description information of the media object, a cover of the media object, a media frame (such as a video frame of a video) of the media object, brief information of media content, and the like. For ease of understanding, the following describes the method with reference to the drawings. FIG. 5 is a schematic diagram of another scene of switching back to playing a first media object according to an embodiment of this disclosure. As shown in FIG. 5, with reference to FIG. 3A, after loading the video stream B, the terminal device may switch to playing the video 30B1 in the video stream B in the media interface 3001. The video 30B1 is the second media object. In the playback process of the video 30B1, the historical replay control element 300b may be outputted and displayed in the media interface 3001, and a historical replay notification may be displayed in the historical replay control element 300b. As shown in FIG. 5, the historical replay notification may include static text information “a video that is just being viewed” and description information of video content of the video 30A3 that is being viewed by the object a when performing the media stream refresh operation (i.e., “The puppy looks completely confused when going outside”). Through the historical replay notification in the historical replay control element 300b, the object a may be prompted to perform the historical replay trigger operation, to switch back to playing the video that is just being viewed, and the video that is switched back for playback specifically refers to the video 30A3. The historical replay trigger operation herein may refer to a trigger operation for the historical replay control element 300b, or may refer to an operation of sliding, in the media interface 3001, in an arrow direction shown in FIG. 4. As shown in FIG. 5, an example in which the object a triggers the historical replay control element 300b is used. After the object a triggers the historical replay control element 300b, the terminal device may respond to this operation and switch the media object played in the media interface 3001 from the video 30B1 back to the video 30A3. For example, as shown in FIG. 5, a final video played in the media interface 3001 is the video 30A3.

In some examples, after the historical replay notification is outputted and displayed in the media interface, display duration of the historical replay notification may be limited in this disclosure. For example, the display duration of the historical replay notification may be limited to 5 s, or the historical replay notification may be limited to being displayed continuously until the object performs a specified operation (such as a media pulling operation or the historical replay trigger operation) in the media interface.

Based on the foregoing description, after the historical replay notification is outputted, displayed duration (the displayed duration refers to duration for which the historical replay notification is displayed) of the historical replay notification may be statistically collected, and when the displayed duration of the historical replay notification reaches a duration threshold, the historical replay notification may be hidden in the media interface. The duration threshold may be a numerical value specifically set based on a service requirement, namely, the duration threshold may be set in a process that the display duration of the historical replay notification is limited. For example, the duration threshold may be set to 5 s, 4 s, 10 s, or the like.

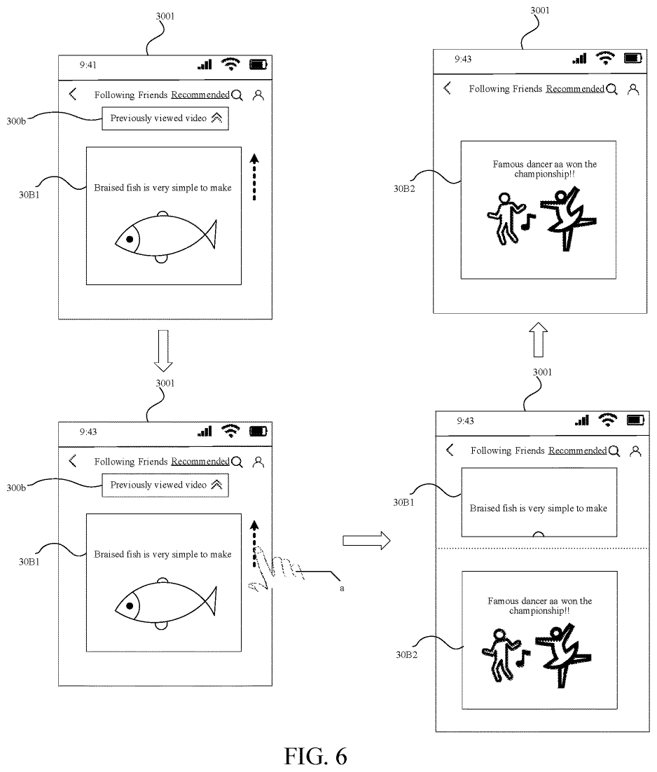

The above describes that after switching to playing the second media object, in the playback process of the second media object, since a retrieval function for historically played media objects is provided in this disclosure, the object may switch back to playing the first media object that is just being viewed, or the object may choose to switch to playing and viewing a next media object in the second media stream. To be specific, in the playback process of the second media object of the second media stream, the object may perform the historical replay trigger operation to switch back to playing the first media object in the first media stream, and may further perform the media pulling operation (i.e., an operation for pulling a next media object that is not viewed of the currently played media object) to pull and play the next media object that is not viewed. For ease of understanding, the process of pulling the media object is described below with reference to the drawings. FIG. 6 is a schematic diagram of a scene of pulling and playing a media object according to an embodiment of this disclosure. As shown in FIG. 6, with reference to FIG. 3A, after loading the video stream B, the terminal device may switch to playing, in the media interface 3001, the video 30B1 in the video stream B. The video 30B1 is the second media object. In the playback process of the video 30B1, the historical replay control element 300b may be outputted and displayed in the media interface 3001, and a historical replay notification (such as static text “a video that is just being viewed” shown in FIG. 4) may be displayed in the historical replay control element 300b. By using the historical replay notification in the historical replay control element 300b, the object a may be prompted to perform the historical replay trigger operation to switch back to playing the video 30A3 that is just being viewed. In some examples, the object a may further perform the media pulling operation to pull and play a next video of the video 30B1. Based on the foregoing description, each media stream in this disclosure may include different media object sequences. Therefore, the second media stream further includes one media object sequence (which may be referred to as a second media object sequence in this disclosure). Based on this, in this embodiment, the second media stream may refer to the video stream B. Since the video sequence included in the video stream B is {the video 30B1, the video 30B 2, the video 30B3, the video 30B4, the video 30B5, the video 30B6, the video 30B7, the video 30B8}, a next video of the video 30B1 may be the video 30B2.

The media pulling operation in this disclosure may at least include, but is not limited to, any one or more of the following types: inputting a specified gesture operation in the media interface (the specified gesture operation herein may refer to a touchscreen sliding operation, a non-contact gesture operation, or the like. For example, the specified gesture operation may refer to sliding a distance in a direction in the media interface); and an operation for inputting utterance data configured for triggering the media pulling operation (namely, the user may input a piece of utterance data by using the terminal device to pull the next media object). A specific meaning of the media pulling operation is illustrated herein with an example for ease of understanding, but this does not mean that a mode for performing the media pulling operation is limited thereto. The mode for performing the media pulling operation is not limited in this disclosure.

As shown in FIG. 6, the media pulling operation may refer to sliding in a direction shown in FIG. 6. If the object a slides a distance in the direction shown in FIG. 6, the terminal device may respond to this operation of the object a and switch the video played in the media interface 3001 from the video 30B1 to the video 30B2. Finally, the video played in the media interface 3001 may be the video 30B2.

As can be seen from the foregoing description and the scene described in an embodiment corresponding to FIG. 6, after the second media object is switched for playback in the media interface, the object may perform the media pulling operation, and the terminal device may respond to the media pulling operation and switch to playing the next media object of the second media object (i.e., the next media object of the second media object in the second media object sequence of the second media stream, where the next media object may be referred to as a fourth media object in this disclosure) in the media interface.

In a specific implementation, the retrieval function for the historically played media objects provided in this disclosure may support retrieving a single media object (such as the first media object described above) that is being viewed before the media stream refresh operation. In this case, in the playback process of the second media object, if the object performs the historical replay trigger operation, the terminal device may respond to this operation and switch back to playing the first media object in the media interface. However, in the playback process of the first media object, if the object performs the media replay operation, in an example that supports the replay of a single media object, the terminal device may not replay the media object again. Instead, the terminal device may reload the media stream and switch to playing the first media object in the new media stream (which may be referred to as a third media stream) in the media interface after the media stream is loaded.

The media replay operation in this disclosure may at least include, but is not limited to, any one or more of the following types: inputting a specified gesture operation in the media interface (the specified gesture operation herein may refer to a touchscreen sliding operation, a non-contact gesture operation, or the like. For example, the specified gesture operation may refer to sliding a distance in a direction in the media interface); and an operation for inputting utterance data configured for triggering the media replay operation (namely, the user may input a piece of utterance data by using the terminal device, to replay the previous media object). A specific meaning of the media replay operation is illustrated herein with an example for ease of understanding, but this does not mean that a mode for performing the media replay operation is limited thereto. The mode for performing the media replay operation is not limited in this disclosure. If the media replay operation and the media pulling operation in this disclosure both refer to sliding along a direction for a distance, the media replay operation and the media pulling operation need to slide in different directions for distinction. In this disclosure, the media replay operation and the historical replay trigger operation may be the same operation.

In a specific implementation, the retrieval function for the historically played media objects provided in this disclosure may support retrieving a whole piece of media stream (such as the first media stream described above) that is viewed before the media stream refresh operation. In this case, in the playback process of the second media object, if the object performs the historical replay trigger operation, the terminal device may respond to this operation and switch back to playing the first media object in the media interface. However, in the playback process of the first media object, if the object performs the media replay operation, since this disclosure supports the replay of the whole piece of media stream, the terminal device may respond to this operation and switch the media object that is played in the media interface to a media object previous to (e.g., being at a position before) the first media object in the first media stream, and if the object performs the media replay operation again, the terminal device may switch back to playing the previous media object again until the first media object of the first media stream is switched back for playback. In this case, there is no media object available for replay in the first media stream. Therefore, in the playback process of the first media object of the first media stream, if the object performs the media replay operation again, the terminal device may load the media stream again and switch to playing the first media object in the new media stream (which may be referred to as a third media stream) in the media interface after loading the media stream.

Based on the foregoing description, the historical replay notification outputted in this disclosure may include relevant information of the media object that can be replayed, to prompt the objects which media object can be replayed. Based on this, in an embodiment of this disclosure, in a case that retrieving the whole piece of media stream (such as the first media stream described above) that is viewed before the media stream refresh operation is supported, the historical replay notification outputted in this disclosure may further include relevant information of all media objects in the media stream that can be replayed (such as title information of each media object, description information of the media object, a cover of the media object, a media frame of the media object (such as a video frame of a video), brief information of media content), and when the relevant information of the media objects is presented, the relevant information of the media objects may be successively presented according to a replay order. For example, using an embodiment corresponding to FIG. 3A as an example, after loading the video stream B, the terminal device may switch to playing the video 30B1 in the video stream B in the media interface 3001, and the video 30B1 is the second media object. In the playback process of the video 30B1, the historical replay control element 300b may be outputted and displayed in the media interface 3001, and the historical replay notification may be displayed in the historical replay control element 300b. The historical replay notification may include static text information “a video that is just being viewed” and relevant information of the video 30A3, the video 30A2, and the video 30A1 that are played and viewed in the video stream A (i.e., the first media stream) viewed by the object a before performing the media stream refresh operation. Herein, an example in which the historical replay notification includes brief information of video content of the videos is used. When the object a views the video 30A1, the video 30A2, and the video 30A3, a playback order is video 30A1->video 30A2->video 30A3. Therefore, a replay order of the three videos is to be: video 30A3->video 30A2->video 30A1. The brief information of video content of the video 30A1 is “The three-point shot stuns everyone.”. The brief information of video content of the video 30A2 is “The cat is so cute that I can't go to work.”. The brief information of video content of the video 30A3 is “The puppy looks completely confused when going outside”. In this way, the brief information of the video content of the video 30A1, the video 30A2, and the video 30A3 may be successively presented in the historical replay notification according to the replay order of the three videos. To be specific, the historical replay notification herein may be specifically referred to as “the videos that are just being viewed are: the puppy looks completely confused when going outside, the cat is so cute that I can't go to work, and the three-point shot stuns everyone”. In some examples, in a case that retrieving the whole piece of media stream (i.e., the first media stream described above) that is viewed before the media stream refresh operation is supported, the historical replay notification outputted in this disclosure may further only include relevant information of the media object (such as the first media object) that is being viewed by the object before the media stream refresh operation. The content included in the historical replay notification is not limited in this disclosure and can be configured to notify the object which specific media object (objects) that can be retrieved.

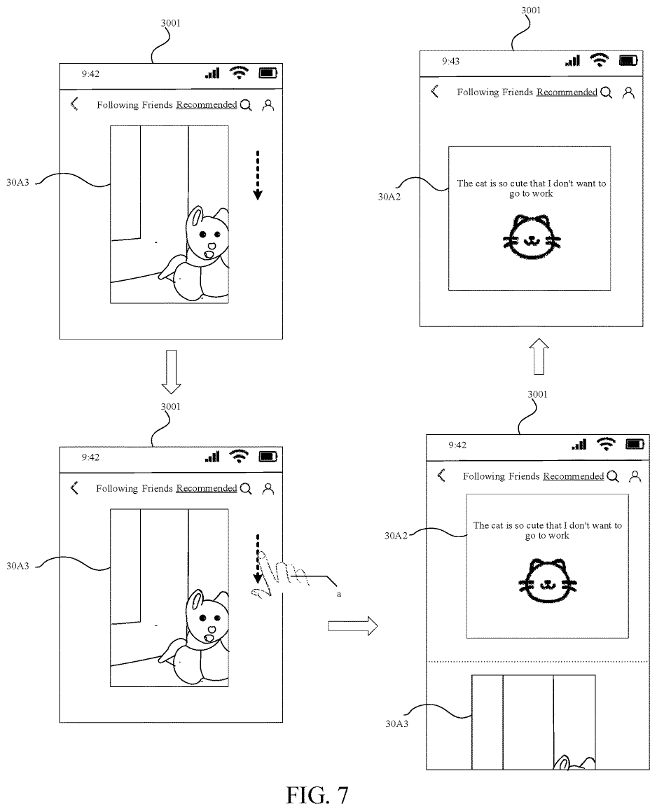

For ease of understanding, FIG. 7 is a schematic diagram of a scene of replaying a media object in a playback process of a first media object according to an embodiment of this disclosure. As shown in FIG. 7, with reference to FIG. 4, after the terminal device switches back to playing the video 30A3, in the playback process of the video 30A3, the object a may perform the media replay operation to switch back to playing a previous video (i.e., the video 30A2 in the video stream A) of the video 30A3, where the video 30A2 is played and viewed by the object a before the video 30A3. The media replay operation in an embodiment corresponding to FIG. 7 may refer to sliding along an arrow direction shown in FIG. 7. As shown in FIG. 7, after the object a performs the media replay operation, the terminal device may respond to this operation and switch the video played in the media interface 3001 from the video 30A3 back to the video 30A2.

Based on the foregoing description and the scene in an embodiment corresponding to FIG. 7, when the first media object in this disclosure is at a non-first position in the first media stream, after the switching back to playing the first media object in the media interface, in the playback process of the first media object, the object may perform the media replay operation to replay the media object previous to the first media object in the first media object sequence of the first media stream. If the object performs the media replay operation, the terminal device may respond to the media replay operation and switch back to playing the preceding media object of the first media object in the media interface (the preceding media object refers to a media object previous to the first media object in the first media object sequence).

Further, after the terminal device switches back to playing the preceding media object of the first media object, if the preceding media object is at the first position in the first media stream, the terminal device may not provide further replay function. Therefore, in the playback process of the preceding media object, if the object performs the media replay operation again, the terminal device may respond to this operation and refresh the media stream again for the object. This media stream is different from the first media stream and different from the second media stream, and is a new media stream that has not been pushed to the object. After the new media stream is loaded, one media object in the new media stream may be switched for playback in the media interface. For example, the media object is at the first position in the new media stream. To be specific, in a case that the preceding media object is at the first position in the first media object sequence, after the preceding media object of the first media object is switched back for playback in the media interface, if the object performs the media replay operation again in the playback process of the preceding media object, the terminal device may display a playback waiting animation in the media interface. The playback waiting animation is configured for indicating that the terminal device is loading the third media stream (i.e., the new media stream different from the first media stream and the second media stream). After the third media stream is loaded, the playback waiting animation may be hidden. In addition, a media object (which may be referred to as a third media object, for example, the first media object in the third media stream may be played) in the third media stream may be switched for playback in the media interface. Correspondingly, in a case that the preceding media object is at a non-first position in the first media object sequence, after the preceding media object of the first media object is switched back for playback in the media interface, if the object performs the media replay operation in the playback process of the preceding media object, the terminal device may switch back to playing the media object previous to the preceding media object (i.e., one media object previous to the preceding media object in the first media object sequence) in the media interface until switching back to playing the first media object in the first media stream. In this case, if the object plays and views the first media object in the first media stream, and performs the media replay operation again, a new media stream may be loaded, and after the new media stream is loaded, one media object (such as the first media object) in the new media stream is played in the media interface.

In some examples, the preceding media object is at the first position in the first media object stream. In some examples, when playback of the preceding media object is in progress and when loading of a third media stream is in progress, a playback waiting animation is displayed in the media interface during the playback of the preceding media object. In some examples, when playback of the preceding media object is in progress and when loading of a third media stream is in progress, and when the loading of the third media stream is completed, the playback waiting animation is hidden, the display of the preceding media object is stopped, and a third media object included in the third media stream is played in the media interface.

In some examples, the first media object is at a first position in the first media object stream. In some examples, when playback of the first media object is in progress and when loading of a third media stream is in progress, a playback waiting animation is displayed in the media interface during the playback of the first media object. In some examples, when playback of the first media object is in progress and when loading of a third media stream is in progress, and when the loading of the third media stream is completed, the playback waiting animation is hidden, the display of the first media object is stopped, and a third media object included in the third media stream is played in the media interface.

In some examples, after the first media object is switched back for playback, if the first media object is at the first position in the first media object sequence, one new media stream may further be refreshed after the object performs the media replay operation. To be specific, in the playback process of the first media object, if the object performs the media replay operation, the terminal device may respond to this media replay operation, display the playback waiting animation in the media interface, and load the third media stream. After the third media stream is loaded, the playback waiting animation may be hidden, and the foregoing third media object is switched for playback in the media interface.

In a possible implementation, in this disclosure, when the first media object is switched back for playback, the first media object may be played from a position at which the first media object is paused. For example, total duration of the first media object is 10 s (i.e., 0 to 10 s), in a process that the object views the first media object, the media stream refresh operation is triggered at the fifth second of the first media object, and the fifth second may be recorded as a playback paused position of the first media object. When the first media object is switched back for playback, the terminal device may start playing from the fifth second of the first media object. Based on this, in this disclosure, when the first media object is switched back for playback in the media interface, historical playback duration of the first media object (i.e., duration for which the object has viewed the first media object, such as 5 s) when responding to the media stream refresh operation may be acquired. A playback start time point of the first media object (such as the fifth second of the first media object) is determined based on the historical playback duration of the first media object. Then, the first media object may be switched back for playback in the media interface by using the playback start time point as a playback start position.

In an embodiment of this disclosure, a media playback solution is provided, which can enrich the media playback functions provided by the media playback platform, to enrich the interaction modes and interaction presentation content with the object. For example, when the first media object in the first media stream is played in the media interface, if the object viewing the first media object triggers performing the media stream refresh operation, it may be considered that the object expects to refresh one new media stream, and the second media object (i.e., one media object in the refreshed second media stream) may be switched for playback in the media interface in response to the media refresh operation. Meanwhile, in this disclosure, the media playback platform provides the replay function for the historically played first media object and first media stream. To be specific, during the playback of the second media object, the object may trigger performing the historical replay trigger operation to view, in the media interface, the first media object that is viewed before the media stream refresh operation is performed or the media object that is already viewed in the first media stream. Thus, in this disclosure, by adding the replay function for the historically played media objects (such as the media objects of the media stream before the media stream refresh operation is performed), the objects can interact with each other by using the historical replay trigger operation on the media playback platform. The media object played by the object is further newly added to the interaction content presented in the media interface. This not only can enrich the interaction modes and interaction presentation content, but also can provide the retrieval function for the historically played media stream when the object mistakenly triggers the media stream refresh operation, thereby improving the user experience.

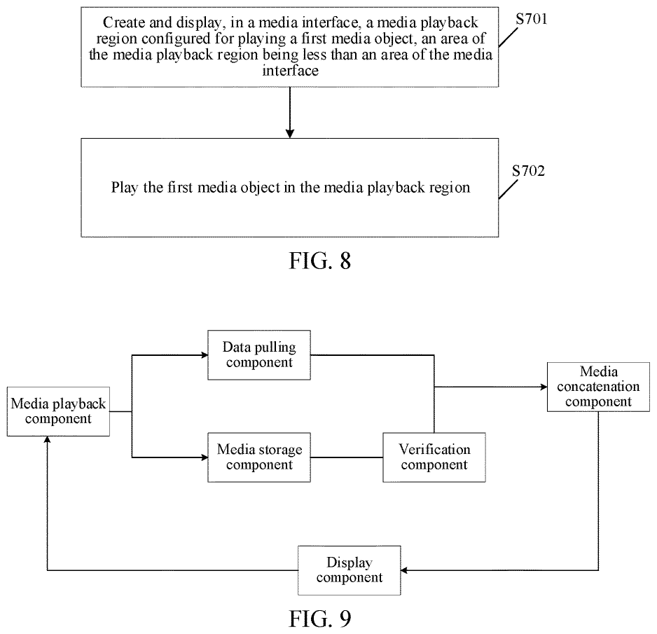

In a possible implementation, in the process of switching back to playing the first media object, a playback region of the first media object may be controlled. For example, the first media object may be displayed in full screen in the media interface, or one region may be created in the media interface as the playback region of the first media object. For ease of understanding, a display mode of the first media object is described below with reference to the drawings. FIG. 8 is a schematic flowchart of playing a first media object in a media interface according to an embodiment of this disclosure. The process may correspond to the process of switching back to playing the first media object in the media interface in an embodiment corresponding to FIG. 2. As shown in FIG. 8, the process may include at least operation S701 to operation S702:

Operation S701: Create and display, in a media interface, a media playback region configured for playing a first media object, where an area of the media playback region is less than an area of the media interface.

In a specific implementation, in the playback process of the second media object, if the object performs the historical replay trigger operation, the terminal device may create, in the media interface, one region that does not extend beyond the media interface as the media playback region of the first media object. The area of the media playback region may be less than the area of the media interface. In this way, the first media object may be understood as being played in small screen in the media interface. In some examples, the first media object may be played independently of the media interface, and when the first media object is played, the playback of the second media object played in the media interface may be paused.

In some examples, for the media playback region, the terminal device may synchronously display a region magnification control element and a close control for the media playback region in the media interface (specifically in the media playback region). The region magnification control element may be configured to adjust (e.g., magnify) a size of the media playback region, and the close control may be configured to close the display of the media playback region. The object may magnify the media playback region of the first media object by performing a trigger operation on the region magnification control element. The object may further close the display of the media playback region, in which the first media object is displayed, by performing a trigger operation on the close control. If the first media object is at a non-first position in the first media object sequence, the object may perform a trigger operation on the region magnification control element to magnify the media playback region, and perform the media replay operation in the playback process of the first media object to replay several media objects previous to the first media object. After the object performs an operation on the close control, the second media object may be continuously played in the media interface.

After the object triggers the region magnification control element, the terminal device may magnify the media playback region including the first media object based on the area of the media interface. Magnifying the media playback region including the first media object based on the area of the media interface herein may refer to displaying the media object played in the media interface in full screen as the first media object (to be specific, the display region of the first media object may occupy the whole interface of the media interface), and the second media object may be hidden.

Operation S702: Play the first media object in the media playback region.

In the specific implementation, in this disclosure, when the first media object is played, the first media object may be played from a position at which the first media object is paused. For example, total duration of the first media object is 10 s (i.e., 0 to 10 s), in the process that the object views the first media object, the media stream refresh operation is triggered at the fifth second of the first media object, and the fifth second may be recorded as the paused position of the first media object. When switching back to playing the first media object, the terminal device may start playing from the fifth second of the first media object. Based on this, when the first media object is played in the media playback region, the first media object may alternatively be played again from the playback paused position of the first media object.

In some examples, when the first media object is switched back for playback, in this disclosure, the first media object may alternatively be played from the beginning. A playback switching mode of the first media object is not limited in this disclosure.

In a specific implementation, after the object performs the media stream refresh operation, validity of the first media object may be verified in this disclosure, to verify whether the first media object meets a playback requirement. If the first media object is already deleted by a media owner, or media content (text content or audio content) of the first media object is invalid, the first media object may not be further played. Even if the object performs the historical replay trigger operation, the first media object may not be replayed. In this case, prompt information indicating that the first media object fails to meet the playback requirement may be displayed in the media interface, or the media object previous to the first media object in the first media stream may be switched back for playback in the media interface.

To be specific, in the playback process of the first media object, if the object performs the media stream refresh operation, the terminal device may further perform validity verification on the first media object, to obtain a validity verification result of the first media object. Only if the validity verification result of the first media object indicates that the first media object is valid, may the terminal device perform the subsequent operation of switching back to playing the first media object in the media interface in response to the historical replay trigger operation. However, if the validity verification result of the first media object indicates that the first media object is invalid, if the object performs the historical replay trigger operation in the playback process of the second media object, the terminal device may respond to the historical replay trigger operation and display prompt information that the first media object fails to meet the playback requirement, or may switch back to playing the media object previous to the first media object (the media object previous to the first media object in the first media object sequence) in the media interface.

In a specific implementation, a specific implementation process of performing validity verification on the first media object to obtain the validity verification result of the first media object may at least include but is not limited to: first, acquiring a permission-to-view object and media content of the first media object, where the permission-to-view object is an object having a permission to view the first media object, and the permission-to-view object may be specifically set by the media owner (which may be a media uploader) of the first media object; determining that the validity verification result of the first media object is a pass result if the permission-to-view object of the first media object includes an operation initiation object of the media stream refresh operation and the media content is valid content, where the pass result may indicate that the first media object is valid; or determining that the validity verification result of the first media object is a failure result if the permission-to-view object of the first media object does not include the operation initiation object of the media stream refresh operation or the media content is invalid content, where the failure result may indicate that the first media object is invalid.

In an embodiment of this disclosure, by adding the replay function for the historically played media objects (such as the media objects of the media stream before the media stream refresh operation is performed), the objects can interact with each other by using the historical replay trigger operation on the media playback platform. The media object played by the object is further newly added to the interaction content presented in the media interface. This not only can enrich the interaction modes and interaction presentation content, but also can provide the retrieval function for the historically played media stream when the object mistakenly triggers the media stream refresh operation, thereby improving the user experience.

Further, FIG. 9 is a diagram of a system interaction logic architecture according to an embodiment of this disclosure. As shown in FIG. 9, the system interaction logic architecture may at least include the following components: a media playback component, a data pulling component, a media storage component, a verification component, a media concatenation component, and a display component. For ease of understanding, functions implemented by the components are briefly described below.

Media playback component: The media playback component may be configured to display, in the media interface, media objects in a current media stream, such as the media objects in the first media stream.

Data pulling component: When a media object in the current media stream of the media playback component is performed, the object may perform the media stream refresh operation, and if the object performs the media stream refresh operation, a network request for refreshing the current media stream may be triggered, and the data pulling component may pull a new media stream (i.e., one new media object sequence: feedlist) from a background server (such as the service server) based on the network request.

Media storage component: When the network request for refreshing the current media stream is triggered, the media storage component may record relevant information (such as an identifier of the media object, a current viewed position, or played duration of the media object) of the media object that is being viewed by the object at the moment when the media stream refresh operation is currently triggered.

Verification component: For the media object recorded by the media storage component, the verification component may verify whether the media object is valid, and the validity herein may at least include: whether the media object is deleted, whether the media object is set to be private, whether media content is valid, and the like. For example, if it is verified that the media object is not deleted yet and not set to be private, and the media content is valid, it may be determined that the media object is valid.

Media concatenation component: The media concatenation component may concatenate the media stream pulled by the data pulling component and the media object based on the validity verification result verified by the verification component; and for example, if the validity verification result of the media object recorded by the media storage component is a pass result, and the pass result may be configured for indicating that the media object is valid, the media concatenation component may concatenate the media object to the top (i.e., located at the head of the new media object sequence) of the new media stream (i.e., the media stream pulled by the data pulling component); and however, if the validity verification result of the media object recorded by the media storage component is a failure result, and the failure result may be configured for indicating that the media object is invalid, the media concatenation component may use the new media stream (i.e., the media stream pulled by the data pulling component) as finally concatenated data.

Display component: The data concatenated by the media concatenation component may be transmitted to the display component, then the display component may return the concatenated data to the media playback component, and the media playback component performs display and playback based on a related operation of the object. In a case that the validity verification result of the media object recorded by the media storage component is the pass result, since the concatenated data is located at the head of the sequence, the object may replay the media object recorded by the media storage component by performing the media replay operation.

In an embodiment of this disclosure, by adding the replay function for the historically played media objects (such as the media objects of the media stream before the media stream refresh operation is performed), the objects can interact with each other by using the historical replay trigger operation on the media playback platform. The media object played by the object is further newly added to the interaction content presented in the media interface. This not only can enrich the interaction modes and interaction presentation content, but also can provide the retrieval function for the historically played media stream when the object mistakenly triggers the media stream refresh operation, thereby improving the user experience.

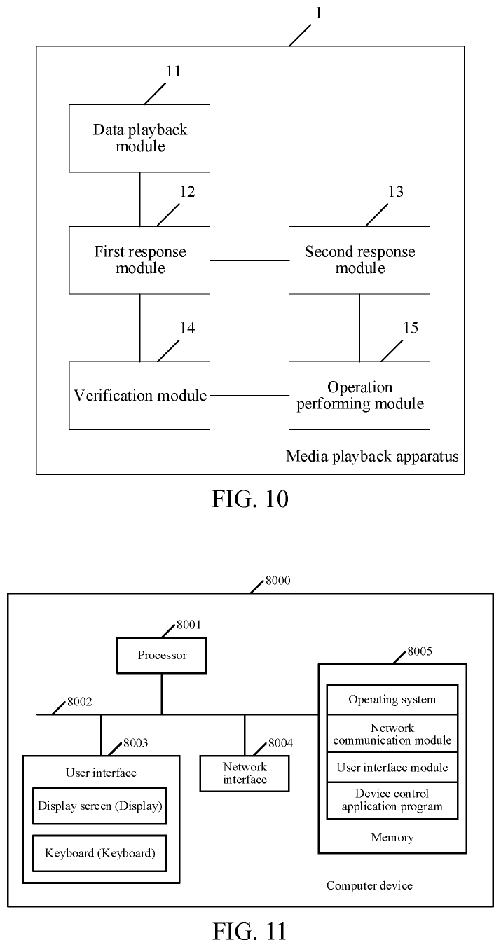

Further, FIG. 10 is a schematic structural diagram of a media playback apparatus according to an embodiment of this disclosure. The media playback apparatus may be a computer program (including program code) run on a computer device. For example, the media playback apparatus is application software. The media playback apparatus may be configured to perform the method shown in FIG. 2. As shown in FIG. 10, a media playback apparatus 1 may include a data playback module 11, a first response module 12, and a second response module 13.

The data playback module 11 is configured to play a first media object in a media interface, the first media object being one media object in a first media stream, and the first media stream including one or more media objects.

The first response module 12 is configured to switch to playing a second media object in the media interface in response to a media stream refresh operation, the second media object being one media object in a refreshed second media stream, and the second media stream including one or more media objects.

The second response module 13 is configured to switch back, in a playback process of the second media object and in response to a historical replay trigger operation, to playing the first media object in the media interface.

For specific implementations of the data playback module 11, the first response module 12, and the second response module 13, refer to the descriptions of operation S101 to operation S103 in the foregoing embodiment corresponding to FIG. 2, and details are not described herein again.

In one embodiment, the second response module 13 is further specifically configured to output a historical replay notification in the playback process of the second media object. The historical replay notification is configured to notify retrieval of a historically played media object by using the historical replay trigger operation.

An output mode of the historical replay notification includes any one of the following types:
outputting in an audio form;
displaying as a dynamic virtual character in a media interface; and
independently displaying, in a static text form, on the second media object in a playback region of the second media object.

In one embodiment, the media interface includes a historical replay control element, and the historical replay notification is displayed in the historical replay control element. The historical replay trigger operation is a trigger operation for the historical replay control element.

In one embodiment, the historical replay notification includes operation guidance of the historical replay trigger operation. The historical replay trigger operation includes an operation performed in the media interface based on a specified operation indicated by the operation guidance.

The specified operation indicated by the operation guidance includes any one of the following:
an operation for inputting a specified gesture in the media interface; and
an operation for inputting utterance data for performing the historical replay operation.

In one embodiment, after the second response module 13 outputs the historical replay notification, the second response module is further specifically configured to perform statistical collection on display duration of the historical replay notification.

The second response module 13 is further specifically configured to hide the historical replay notification in the media interface when the display duration of the historical replay notification reaches a duration threshold.

In one embodiment, the first media stream includes a first media object sequence, the first media object is at a non-first position in the first media object sequence, and the media stream refresh operation is a scroll-to-top operation.

A specific implementation for the second response module 13 to switch to playing the second media object in the media interface includes:
switch to playing the historically played media object in the media interface, and display a playback waiting animation in the media interface during the playback of the historically played media object, where the historically played media object is at the first position in the first media object sequence; and
hide the playback waiting animation after the second media stream is loaded, and switch to playing the second media object in the media interface.

In one embodiment, the first media object is at the first position in the first media stream.

A specific implementation for the second response module 13 to switch to playing the second media object in the media interface includes:
display the playback waiting animation in the media interface; and
hide the playback waiting animation after the second media stream is loaded, and switch to playing the second media object in the media interface.

In one embodiment, the first media stream includes a first media object sequence, and the first media object is at a non-first position in the first media stream.

After the second response module 13 switches back to playing the first media object in the media interface, the second response module 13 is further specifically configured to switch back, in the playback process of the first media object, to playing a preceding media object of the first media object in the media interface in response to the media replay operation. The preceding media object refers to a media object previous to the first media object in the first media object sequence.

In one embodiment, the preceding media object is at the first position in the first media object sequence.

After the second response module 13 switches back to playing the preceding media object of the first media object in the media interface, the second response module 13 is further specifically configured to display, in the playback process of the preceding media object, the playback waiting animation in the media interface in response to the media replay operation.

The second response module 13 is further specifically configured to hide the playback waiting animation after a third media stream is loaded, and switch to playing a third media object in the media interface, where the third media object refers to one media object in the third media stream.

The first media stream includes a first media object sequence, and the first media object is at the first position in the first media object sequence.

After the second response module 13 switches back to playing the first media object in the media interface, the second response module is further specifically configured to display, in the playback process of the first media object, the playback waiting animation in the media interface in response to the media replay operation.

The second response module 13 is further specifically configured to hide the playback waiting animation after the third media stream is loaded, and switch to playing the third media object in the media interface, where the third media object refers to one media object in the third media stream.

In one embodiment, the second media stream includes a second media object sequence.

After the first response module 12 switches to playing the second media object in the media interface, the first response module 12 is further specifically configured to switch to playing a fourth media object in the media interface in response to a media pulling operation, where the fourth media object refers to a next media object of the second media object in the second media object sequence.

In one embodiment, the second response module 13 switches back to playing the first media object in the media interface, which includes:
create and display, in the media interface, a media playback region configured for playing the first media object, where an area of the media playback region is less than an area of the media interface; and
play the first media object in the media playback region.

In one embodiment, when the media playback region is displayed in the media interface, the media interface further displays a region magnification control element for the media playback region.

After the second response module 13 plays the first media object in the media playback region, the second response module 13 is further specifically configured to magnify, in response to a trigger operation for the region magnification control element and based on the area of the media interface, the media playback region including the first media object.

In one embodiment, a specific implementation for the second response module 13 to switch back, in response to the historical replay trigger operation, to playing the first media object in the media interface includes:
acquire, in response to the historical replay trigger operation, historical playback duration of the first media object when responding to the media stream refresh operation;
determine a playback start time point of the first media object based on the historical playback duration of the first media object; and
switch back to playing the first media object in the media interface by using the playback start time point as a playback start position.

In one embodiment, the media playback apparatus 1 further includes a verification module 14 and an operation performing module 15.

The verification module 14 is configured to perform validity verification on the first media object to obtain a validity verification result of the first media object.

The operation performing module 15 is configured to perform an operation of switching back to playing the first media object in the media interface if the validity verification result of the first media object indicates that the first media object is valid.

In one embodiment, a specific implementation for the verification module 14 to perform validity verification on the first media object to obtain the validity verification result of the first media object includes:
acquire a permission-to-view object and media content of the first media object, where the permission-to-view object refers to an object having a permission to view the first media object;
determine that the validity verification result of the first media object is a pass result if the permission-to-view object of the first media object includes an operation initiation object of the media stream refresh operation and the media content is valid content; or
determine that the validity verification result of the first media object is a failure result if the permission-to-view object of the first media object does not include the operation initiation object of the media stream refresh operation, or the media content is invalid content.

For specific implementations of the verification module 14 and the operation performing module 15, refer to the related description of operation S702 in an embodiment corresponding to FIG. 8, and details are not described herein again.

In an embodiment of this disclosure, a media playback solution is provided, which can enrich the media playback functions provided by the media playback platform, to enrich the interaction modes and interaction presentation content with the object. For example, when the first media object in the first media stream is played in the media interface, if the object viewing the first media object triggers performing the media stream refresh operation, it may be considered that the object expects to refresh one new media stream, and the second media object (i.e., one media object in the refreshed second media stream) may be switched for playback in the media interface in response to the media refresh operation. Meanwhile, in this disclosure, the media playback platform provides the replay function for the historically played first media object and first media stream. To be specific, during the playback of the second media object, the object may trigger performing the historical replay trigger operation to view, in the media interface, the first media object that is viewed before the media stream refresh operation is performed or the media object that is already viewed in the first media stream. Thus, in this disclosure, by adding the replay function for the historically played media objects (such as the media objects of the media stream before the media stream refresh operation is performed), the objects can interact with each other by using the historical replay trigger operation on the media playback platform. The media object played by the object is further newly added to the interaction content presented in the media interface. This not only can enrich the interaction modes and interaction presentation content, but also can provide the retrieval function for the historically played media stream when the object mistakenly triggers the media stream refresh operation, thereby improving the user experience.

Further, FIG. 11 is a schematic structural diagram of a computer device according to an embodiment of this disclosure. As shown in FIG. 11, the computer device 8000 may include processing circuitry (e.g., a processor 8001), a network interface 8004, and a memory 8005. The computer device 8000 further includes a user interface 8003 and at least one communication bus 8002. The communication bus 8002 is configured to implement connection and communication between these components. The user interface 8003 may include a display, a keyboard, and in some embodiments, the user interface 8003 may further include a standard wired interface and a standard wireless interface. In some embodiments, the network interface 8004 may include a standard wired interface and a standard wireless interface (such as a Wi-Fi interface). In some examples, the memory 8005 may include a non-transitory computer-readable storage medium. The memory 8005 may be a high-speed random-access memory (RAM) or a non-volatile memory, such as at least one disk memory. In some embodiments, the memory 8005 may further be at least one storage apparatus that is located far away from the foregoing processor 8001. As shown in FIG. 11, the memory 8005 used as a non-transitory computer-readable storage medium may include an operating system, a network communication module, a user interface module, and a device-control application program.

In the computer device 8000 shown in FIG. 11, the network interface 8004 may provide a network communication function. The user interface 8003 is mainly configured to provide an interface for a user to input. The processor 8001 may be configured to invoke the device-control application program stored in the memory 8005 to:
play a first media object in a media interface, the first media object being one media object in a first media stream, and the first media stream including one or more media objects;
switch to playing a second media object in the media interface in response to a media stream refresh operation, the second media object being one media object in a refreshed second media stream, and the second media stream including one or more media objects; and
switch back, in a playback process of the second media object and in response to a historical replay trigger operation, to playing the first media object in the media interface.

In an embodiment of this disclosure, the computer device 8000 may perform the description of the media playback method in an embodiment corresponding to FIG. 2 or the description of the media playback apparatus 1 in an embodiment corresponding to FIG. 10. Details are not described herein again. In addition, the description of beneficial effects of the same method is not described herein again.

In addition, an embodiment of this disclosure further includes a non-transitory computer-readable storage medium. The non-transitory computer-readable storage medium stores a computer program executed by the computer device 8000 for data processing mentioned above, and the computer program includes program instructions. When executing the program instructions, a processor can perform the descriptions of the media playback method in the foregoing embodiment corresponding to FIG. 2. Therefore, details are not described herein again. In addition, the description of beneficial effects of the same method is not described herein again. For technical details that are not disclosed in the non-transitory computer-readable storage medium embodiments of this disclosure, refer to the descriptions of the method embodiments of this disclosure.

The foregoing non-transitory computer-readable storage medium may be the media playback apparatus provided in any one of the foregoing embodiments or an internal storage unit of the foregoing computer device, such as a hard disk or an internal memory of the computer device. The non-transitory computer-readable storage medium may further be an external storage device of the computer device, such as a plug-type hard disk, a smart media card (SMC), a secure digital (SD) card, and a flash card that are configured on the computer device. Further, the non-transitory computer-readable storage medium may further include the internal storage unit of the computer device, and include the external storage device. The non-transitory computer-readable storage medium is configured to store the computer program and other programs and data for the computer device. The non-transitory computer-readable storage medium may further be configured to temporarily store the outputted data or to-be-outputted data.

In an aspect of this disclosure, a computer program product is provided, including a computer program, where the computer program is stored in a non-transitory computer-readable storage medium. Processing circuitry (e.g., a processor) of a computer device reads the computer program from the non-transitory computer-readable storage medium and executes the computer program to cause the computer device to perform the method provided in an aspect of this disclosure.

Terms “first” and “second” in the specification, claims, and drawings of one or more embodiments of this disclosure are configured for distinguishing different objects, and are not configured for describing a specific sequence. In addition, the term “including”, or any other variant thereof is intended to cover a non-exclusive inclusion. For example, a process, a method, an apparatus, a product, or a device including a series of steps or units is not limited to the listed steps or modules, but instead, in some embodiments, includes steps or modules that are not listed, or in some embodiments, includes other steps or units inherent to the process, method, apparatus, product, or device. As used herein, the phrase “at least one of A, B, or C” or “one or more of A, B, or C” is intended to mean any one or a combination of A, B, or C, including “A,” “B,” “C,” “A and B,” “A and C,” “B and C,” or “A, B, and C.”

In an embodiment of this disclosure, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an integrated module or unit including the module or unit function.

A person having ordinary skill in the art can realize that units and algorithm steps of various examples described in one or more embodiments disclosed herein can be implemented by electronic hardware, computer hardware or a combination of the two. In order to clearly illustrate the interchangeability of the hardware and the software, the composition and steps of each example are already described generally in accordance with functions in the above description. Whether these functions are executed with hardware or software depends on the specific application and designed constraint conditions of the technical solution. Professional technicians can use different methods to implement the described functions for each specific application, but such implementation is not to be considered beyond the scope of this disclosure.

The method and the related apparatus provided in one or more embodiments of this disclosure are described with reference to the method flowcharts and/or the schematic diagrams of the structures provided in one or more embodiments of this disclosure. For example, each procedure and/or block in the method flowcharts and/or the schematic diagrams of the structures and a combination of a procedure and/or a block in the flowcharts and/or the block diagrams may be implemented by using computer program instructions. The computer program instructions may be provided to a general-purpose computer, a dedicated computer, an embedded processing machine, or a processor of another programmable data processing device, to generate a machine, so that the instructions executed by the computer or the processor of the another programmable data processing device generate an apparatus configured to implement the functions specified in one or more processes of the flowcharts and/or one or more blocks of the schematic diagrams of the structures. These computer program instructions may alternatively be stored in a non-transitory computer-readable memory that can guide a computer or another programmable data processing device to operate in a specific manner so that the instructions stored in the non-transitory computer-readable memory generate an artifact including an instruction apparatus. The instruction apparatus implements the functions specified in one or more processes in the flowcharts and/or one or more blocks in the schematic structural diagrams. The computer program instructions may alternatively be loaded onto a computer or another programmable data processing device, so that a series of operations are performed on the computer or the another programmable device to generate processing implemented by a computer. Therefore, the instructions executed on the computer or the another programmable device provide operations for implementing the functions specified in one or more processes of the flowcharts and/or one or more blocks of the schematic diagrams of the structures.

What is disclosed above corresponds to non-limiting embodiments of this disclosure, and is not intended to limit the scope of this disclosure. Therefore, variations made in accordance with the disclosure shall fall within the scope of this disclosure.

What is claimed is:

1. A media playback method, the method comprising:
playing a first media object in a media interface, the first media object being one of one or more media objects included in a first media stream;
receiving a first user operation that triggers a media stream refresh function during playback of the first media object;
based on the media stream refresh function being triggered by the first user operation:
recording media information of the first media object;
stopping the playback of the first media object;
playing a second media object in the media interface, the second media object being one of one or more media objects included in a refreshed second media stream; and
displaying a historical replay control element in the media interface during playback of the second media object;
receiving a second user operation on the historical replay control element; and
based on the second user operation being performed on the historical replay control element:
performing validity verification on the first media object to obtain a validity verification result of the first media object;
when the validity verification result of the first media object indicates that the first media object is valid, playing the first media object in the media interface; and
when the validity verification result of the first media object indicates that the first media object is invalid,
displaying an invalidity notification indicating that the first media object is not valid for playback, or
playing another media object included in the first media stream in the media interface.

2. The method according to claim 1, further comprising:
outputting a historical replay notification with display of the historical replay control element, the historical replay notification including:
an audio notification;
a dynamic virtual character displayed in the media interface; or
a static text notification displayed in a playback region of the second media object.

3. The method according to claim 2, wherein the historical replay notification is displayed in the historical replay control element.

4. The method according to claim 2, wherein
the historical replay notification includes operation guidance of the second user operation; and
the second user operation indicated by the operation guidance includes:
an operation for inputting a specified gesture in the media interface; or
an operation for inputting utterance data.

5. The method according to claim 2, further comprising:
hiding display of the historical replay notification in the media interface when a displayed duration of the historical replay notification reaches a duration threshold.

6. The method according to claim 1, wherein
the first media object is at a non-first position in the first media object stream;
the media stream refresh function corresponds to a scroll-to-top operation; and
the method further includes, based on the media stream refresh function being triggered by the first user operation:
when the second media stream is loading after the playback of the first media object is stopped, playing, in the media interface, a top media object that is at a first position in the first media object stream and displaying a playback waiting animation in the media interface during playback of the top media object; and
when the loading of the second media stream is completed, hiding the playback waiting animation, stopping the display of the top media object, and starting the playback of the second media object in the media interface.

7. The method according to claim 1, wherein
the first media object is at a first position in the first media stream; and
the method further includes, based on the media stream refresh function being triggered by the first user operation:
when the second media stream is loading, displaying a playback waiting animation in the media interface during playback of the first media object; and
when the loading of the second media stream is completed, hiding the playback waiting animation, stopping the playback of the first media object, and starting the playback of the second media object in the media interface.

8. The method according to claim 1, wherein
the first media object is at a non-first position in the first media stream; and
the method further includes:
during playback of the first media object based on the second user operation being performed on the historical replay control element,
playing a preceding media object of the first media object in the media interface based on a media replay operation, the preceding media object being at a position before the first media object in the first media object stream.

9. The method according to claim 8, wherein
the preceding media object is at the first position in the first media object stream; and
the method further includes:
during playback of the preceding media object and loading of a third media stream, displaying a playback waiting animation in the media interface; and
when the loading of the third media stream is completed, hiding the playback waiting animation, stopping the display of the preceding media object, and playing a third media object included in the third media stream in the media interface.

10. The method according to claim 1, wherein
the first media object is at a first position in the first media object stream; and
the method further includes:
during playback of the first media object and loading of a third media stream, displaying a playback waiting animation in the media interface; and
when the loading of the third media stream is completed, hiding the playback waiting animation, stopping the display of the first media object, and playing a third media object included in the third media stream in the media interface.

11. The method according to claim 1, further comprising:
stopping the display of the second media object and playing a fourth media object in the media interface based on a media pulling function, the fourth media object being next to the second media object in the second media object stream.

12. The method according to claim 1, further comprising:
creating and displaying a media playback region in the media interface, an area of the media playback region being less than an area of the media interface; and
playing the first media object in the media playback region.

13. The method according to claim 12, further comprising:
when the media playback region is displayed in the media interface, displaying a region magnification control element for the media playback region in the media interface; and
adjusting a size of the media playback region based on a trigger operation performed on the region magnification control element.

14. The method according to claim 1, further comprising:
determining a playback start point of the first media object based on a historical playback duration of the first media object included in the media information of the first media object,
wherein the playing the first media object based on the second user operation being performed on the historical replay control element includes playing the first media object in the media interface at a playback start position based on the playback start point.

15. The method according to claim 1, wherein the performing the validity verification on the first media object comprises:
obtaining a permission-to-view object and media content of the first media object, the permission-to-view object corresponding to an object having a permission to view the first media object;
determining the validity verification result indicates the first media object is valid when the permission-to-view object of the first media object includes an operation initiation object of the media stream refresh function and the media content is valid; and
determining the validity verification result indicates the first media object is invalid when the permission-to-view object of the first media object does not include the operation initiation object of the media stream refresh function, or the media content is invalid.

16. A media playback apparatus, comprising:
processing circuitry configured to:
play a first media object in a media interface, the first media object being one of one or more media objects included in a first media stream;
receive a first user operation that triggers a media stream refresh function during playback of the first media object;
based on the media stream function being triggered by the first user operation:
record media information of the first media object;
stop the playback of the first media object;
play a second media object in the media interface, the second media object being one of one or more media objects included in a refreshed second media stream; and
display a historical replay control element in the media interface during playback of the second media object;
receive a second user operation on the historical replay control element; and
based on the second user operation being performed on the historical replay control element:
perform validity verification on the first media object to obtain a validity verification result of the first media object;
when the validity verification result of the first media object indicates that the first media object is valid, play the first media object in the media interface; and
when the validity verification result of the first media object indicates that the first media object is invalid,
display an invalidity notification indicating that the first media object is not valid for playback, or
play another media object included in the first media stream in the media interface.

17. The apparatus according to claim 16, wherein the processing circuitry is configured to:
output a historical replay notification with display of the historical replay control element, the historical replay notification including:
an audio notification;
a dynamic virtual character displayed in the media interface; or
a static text notification displayed in a playback region of the second media object.

18. The apparatus according to claim 17, wherein
the historical replay notification includes operation guidance of the second user operation; and
the second user operation indicated by the operation guidance includes:
an operation for inputting a specified gesture in the media interface; or
an operation for inputting utterance data.

19. The apparatus according to claim 17, wherein the processing circuitry is configured to:
stop display of the historical replay notification in the media interface when a displayed duration of the historical replay notification reaches a duration threshold.

20. A non-transitory computer-readable storage medium storing instructions, which when executed by a processor, cause the processor to perform a media playback method, the method comprising:
playing a first media object in a media interface, the first media object being one of one or more media objects included in a first media stream;
receiving a first user operation that triggers a media stream refresh function during playback of the first media object;
based on the media stream refresh function being triggered by the first user operation:
recording media information of the first media object;
stopping the playback of the first media object;
playing a second media object in the media interface, the second media object being one of one or more media objects included in a refreshed second media stream; and
displaying a historical replay control element in the media interface during playback of the second media object;
receiving a second user operation on the historical replay control element; and
based on the second user operation being performed on the historical replay control element:
performing validity verification on the first media object to obtain a validity verification result of the first media object;
when the validity verification result of the first media object indicates that the first media object is valid, playing the first media object in the media interface; and
when the validity verification result of the first media object indicates that the first media object is invalid,
displaying an invalidity notification indicating that the first media object is not valid for playback, or
playing another media object included in the first media stream in the media interface.
